(19) United States
(12) Patent Application Publication
(10) Pub. No.: US 2024/0143161 A1
(43) Pub. Date: May 2, 2024

(54) SYSTEM AND METHOD FOR DIGITIZING AND MINING HANDWRITTEN NOTES TO ENABLE REAL-TIME COLLABORATION

(71) Applicant: KPMG LLP, NEW YORK, NY (US)

(72) Inventors: Michael Sisselman, Lakeville, CT (US); Andrew Berisha-Cornejo, Stamford, CT (US); W. Evan Durno, Seattle, WA (US); Xiaoyu Yu, New York, NY (US)

(21) Appl. No.: 18/384,118

(22) Filed: Oct. 26, 2023

Related U.S. Application Data
(60) Provisional application No. 63/419,390, filed on Oct. 26, 2022.

(51) Int. Cl. G06F 3/04883; G06F 40/40

(52) U.S. Cl. CPC G06F 3/04883; G06F 40/40

(57) ABSTRACT

The invention relates to computer-implemented systems and methods for automatically discerning creation of handwritten verbiage (or typed) on a digital display; converting it to digital text objects that have been repaired (e.g., spelling, punctuation, etc.); and then inserting it as Scalable Vector Graphics onto the display.

### CROSS REFERENCE TO RELATED APPLICATIONS

The application claims priority to U.S. Provisional Application No. 63/419,390 (Attorney Docket No. 055089.0000097), filed Oct. 26, 2022, the contents of which are incorporated by reference herein in their entirety.

### FIELD OF THE INVENTION

The present invention relates to systems and methods for digitizing and mining handwritten or typed notes to derive insights and enable improved collaboration and real-time analysis and insights.

### BACKGROUND

Global entities regularly use collaborative centers where attendees can explore data and discuss emerging technologies and their applications to complex business challenges. With a focus on facilitating collaboration and stimulating creativity, such collaborative centers provide a unique environment for entities and clients to work together to tackle client issues through data, analytics and AI (DA/AI), to ideate on challenges and opportunities related to strategy, operations, transformation, and use of DA/AI to drive business outcomes.

Generally, participants will write notes throughout a session to capture comments, questions, and insights. Participants may include client stakeholders and facilitators. At times, annotations pertain to artifacts presented or to live demonstrations. Other times, annotations are part of an interactive exercise. While the act of scribing is engaging and useful in the moment, it is difficult to propagate this content for subsequent use during and beyond the session. It is also difficult to synthesize discrete notes into broader, holistic themes as well as assign attribution to annotations.

It would be desirable, therefore, to have a system and method that could overcome the foregoing disadvantages of known systems.

### SUMMARY

According to an embodiment, the invention relates to a computer-implemented system that digitizes and mines handwritten notes to support real-time collaboration. The system comprises: an interface that communicates with a digital touch interface at a location during a collaboration session; and a computer processor that is connected to the interface and further programmed to perform the steps of: applying computer vision processing to parse an image displayed on the digital touch interface into a set of objects that comprise a set of handwritten notes; performing optical character recognition processing on the set of handwritten notes to identify a corresponding set of text strings; applying a natural language processing to correct errors wherein the errors comprise typographical errors and punctuation; applying the natural language processing to create a word cloud graphic based on the corresponding set of text strings wherein the word cloud graphic is based on a metric; applying the natural language processing to identify one or more keywords based on the set of text strings and making the one or more keywords available in real-time; applying the natural language processing to attribute authorship to each of the text strings based on a writing sample and making the authorship available in real-time; applying a recommender engine to identify one or more suggestions that support the set of text strings and making the one or more suggestions in real-time; and applying a classifier to identify relationships between the set of text strings and making the relationships available in real-time. In addition, an embodiment of the present invention may automatically summarize digital notes using Generative AI.

According to another embodiment, the invention relates to a computer-implemented method that digitizes and mines handwritten notes to support real-time collaboration. The method comprises the steps of: applying, via a computer processor, computer vision processing to parse an image displayed on a digital touch interface into a set of objects that comprise a set of handwritten notes, wherein the set of handwritten notes are captured during a collaboration session at a location; performing, via the computer processor, optical character recognition processing on the set of handwritten notes to identify a corresponding set of text strings; applying, via the computer processor, a natural language processing to correct errors wherein the errors comprise typographical errors and punctuation; applying, via the computer processor, the natural language processing to create a word cloud graphic based on the corresponding set of text strings wherein the word cloud graphic is based on a metric; applying, via the computer processor, the natural language processing to identify one or more keywords based on the set of text strings and making the one or more keywords available in real-time; applying, via the computer processor, the natural language processing to attribute authorship to each of the text strings based on a writing sample and making the authorship available in real-time; applying, via the computer processor, a recommender engine to identify one or more suggestions that support the set of text strings and making the one or more suggestions in real-time; and applying, via the computer processor, a classifier to identify relationships between the set of text strings and making the relationships available in real-time. In addition, an embodiment of the present invention may automatically summarize digital notes using Generative AI.

The invention also relates to computer-implemented system that digitizes and mines handwritten notes to support real-time collaboration, and to a computer-readable medium containing program instructions for executing a method for digitizing and mining handwritten notes to support real-time collaboration.

An embodiment of the present invention is directed to providing a solution that digitizes and then mines handwritten notes in real-time. The innovation may use an application program interface (API) to extract a graphical image containing annotations. The graphical image may be extracted from a canvas on a digital touch platform or other user interface. An embodiment of the present invention may leverage functionality described in U.S. Pat. No. 10,846,341, “System and Method for Analysis of Structured and Unstructured Data,” and continuation application U.S. patent application Ser. No. 17/100,019, the contents of which are incorporated by reference herein in their entirety.

An embodiment of the present invention may implement Computer Vision (CV) technology to parse an image into logical sub-regions, Optical Character Recognition (OCR) to convert handwritten notes to a string of text; and Natural Language Processing (NLP) to repair (e.g., spell check, etc.), to embellish (e.g., punctuation, capitalization, etc.), and to mine (e.g. keywords, topics, sentiment, etc.). The innovation may access the CV technology through external applications through an API.

For example, an embodiment of the present invention may use NLP to discern sentiment, for topic-modeling and to generate summarizations. Also, an embodiment of the present invention may be directed to submitting a query to a backend corpus of ingested content to support a “search” functionality in a question-answer paradigm.

An embodiment of the present invention may realize technical benefits and advantages including providing a captivating experience (e.g., Prioritized Roadmap, etc.); realizing potential to build benchmarks on session metadata (e.g., moments that matter, friction, common themes, etc.); ingesting content for downstream sessions; and generating synthesized, professional read-out for clients and other users and participants.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flow diagram, according to an embodiment of the present invention.

FIG. 2 is an illustration of applying OCR to a handwritten note and then generating a text string, according to an embodiment of the present invention.

FIG. 3 illustrates how the system corrects a typographical error, according to an embodiment of the present invention.

FIG. 4 illustrates applying a correction to punctuation, according to an embodiment of the present invention.

FIG. 5 illustrates how the system operates on multiple digital notes, according to an embodiment of the present invention.

FIG. 6 illustrates an example of a word cloud, according to an embodiment of the present invention.

FIG. 7 illustrates a keyword search, according to an embodiment of the present invention.

FIG. 8 illustrates an example of moving highlighted digital notes on another graphic, according to an embodiment of the present invention.

FIG. 9 illustrates an example where a financial theme has been identified, according to an embodiment of the present invention.

FIG. 10A illustrates how handwriting may be used to attribute authorship, according to an embodiment of the present invention.

FIG. 10B illustrates author attribution, according to an embodiment of the present invention.

FIG. 11 illustrates how sentiment may be identified, according to an embodiment of the present invention.

FIG. 12 illustrates suggestions, according to an embodiment of the present invention.

FIG. 13 illustrates how digital notes may be categorized, according to an embodiment of the present invention.

FIG. 14A is an exemplary system diagram, according to an embodiment of the present invention.

FIG. 14B is an example of a generate command, according to an embodiment of the present invention.

FIG. 14C is an example of a generate command, according to an embodiment of the present invention.

FIG. 14D illustrates capturing digital notes, according to an embodiment of the present invention.

FIG. 14E illustrates analysis of digital notes, according to an embodiment of the present invention.

FIG. 15 illustrates an exemplary logical architecture, according to an embodiment of the present invention.

FIG. 16 illustrates an exemplary physical architecture, according to an embodiment of the present invention.

FIG. 17 illustrates an exemplary process flow, according to an embodiment of the present invention.

FIG. 18 illustrates an exemplary process flow, according to an embodiment of the present invention.

FIG. 19 illustrates an exemplary process flow, according to an embodiment of the present invention.

FIG. 20 illustrates an exemplary data flow, according to an embodiment of the present invention.

FIG. 21 illustrates an exemplary data flow, according to an embodiment of the present invention.

FIG. 22 illustrates an exemplary data flow, according to an embodiment of the present invention.

FIG. 23 illustrates an exemplary flowchart that describes searching and highlighting keywords, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to automatically discerning creation of handwritten verbiage on a digital display; converting it to digital text objects that have been repaired (e.g., spelling, punctuation, etc.); and then inserting it as Scalable Vector Graphics onto the digital display. An embodiment of the present invention may execute a backend process that watches for insertion of a new note object. Once detected, the system may take action seamlessly or simply mark it for a subsequent action.

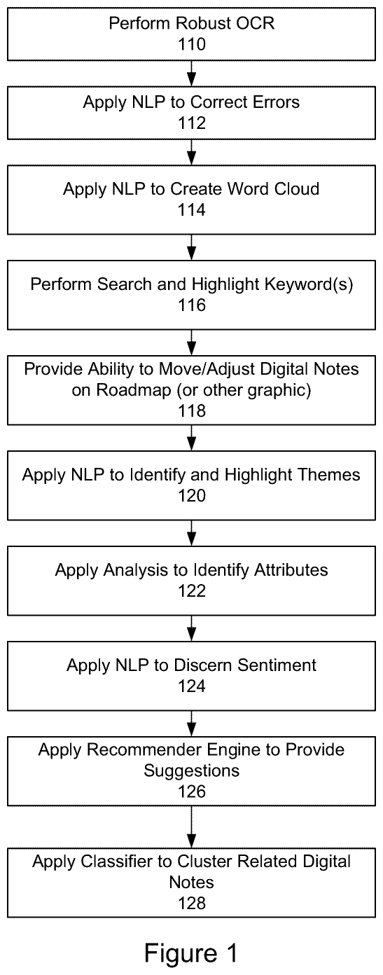

FIG. 1 is an exemplary flow diagram, according to an embodiment of the present invention. At step 110, a system may perform optical character recognition (OCR) on an image to convert it to a text format. At step 112, natural language processing (NLP) may be applied to correct errors, such as typographical errors, punctuation, etc. At step 114, NLP may be applied to create a word cloud or other graphic that represents word frequency, importance and/or other metric. At step 116, the system may perform a search function to identify and highlight keywords including variations (e.g., stemming, etc.) thereof. At step 118, the system may provide the ability to move and/or adjust digital notes (e.g., stickies) on an icon, a graphic and/or other visual interface, such as a roadmap, etc. At step 120, NLP may be applied to identify and highlight themes (e.g., financial, booster, blockers, etc.). At step 122, analytics may be applied to identify attributes, such as authorship. At step 124, NLP may be applied to discern sentiment (e.g., positive, negative, neutral, etc.). At step 126, a recommender engine may be applied to provide suggestions. At step 128, a classifier may be applied to cluster related digital notes. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

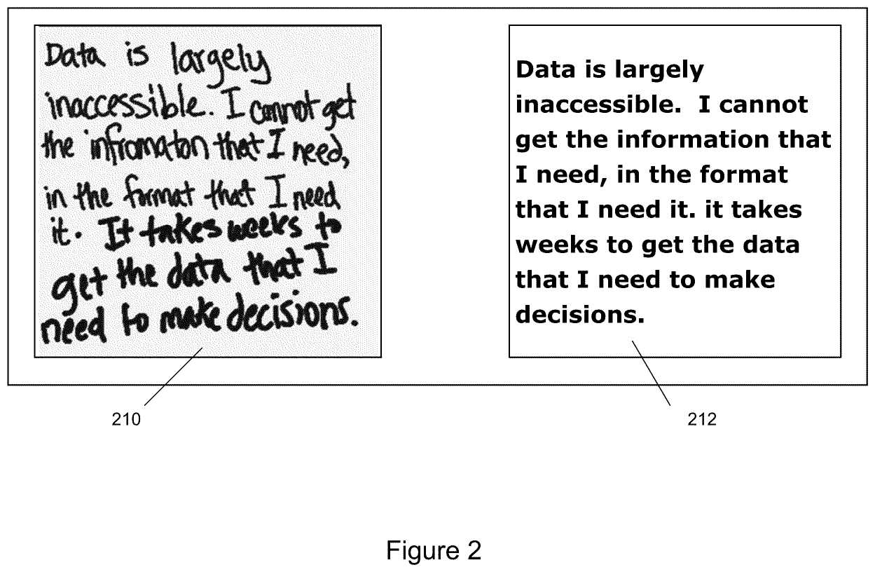

At step 110, a system may perform optical character recognition (OCR) on an image of text to convert the image into a text format. The image of text may represent a handwritten text on a small sized graphical note, such as a sticky note. FIG. 2 is an illustration of applying OCR to a handwritten note 210 or sticky and then generating a text string 212, according to an embodiment of the present invention. A sticky generally refers to a graphical representation of a handwritten note. Using a writing tool, a participant may handwrite a note on a touchscreen interface or canvas. According to another example, an embodiment of the present invention may also recognize and digitize diagrams, drawings and/or other hand-drawn images. Writing tools may include an infrared stylus, finger on a touchscreen, etc. An embodiment of the present invention is generally directed to digital notes (e.g., stickies); however, other annotations may be supported. This may include annotations superimposed on graphic objects (e.g., JPEG, PDF, etc.) or on the canvas itself.

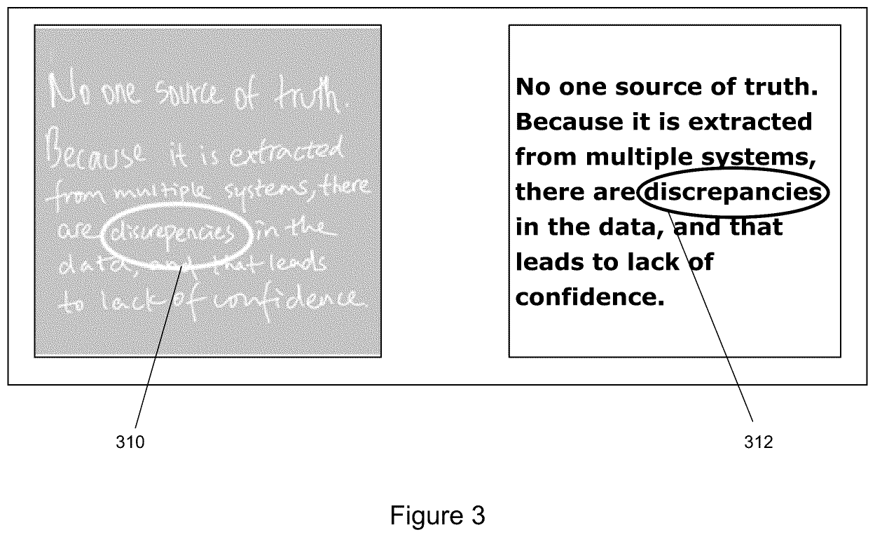

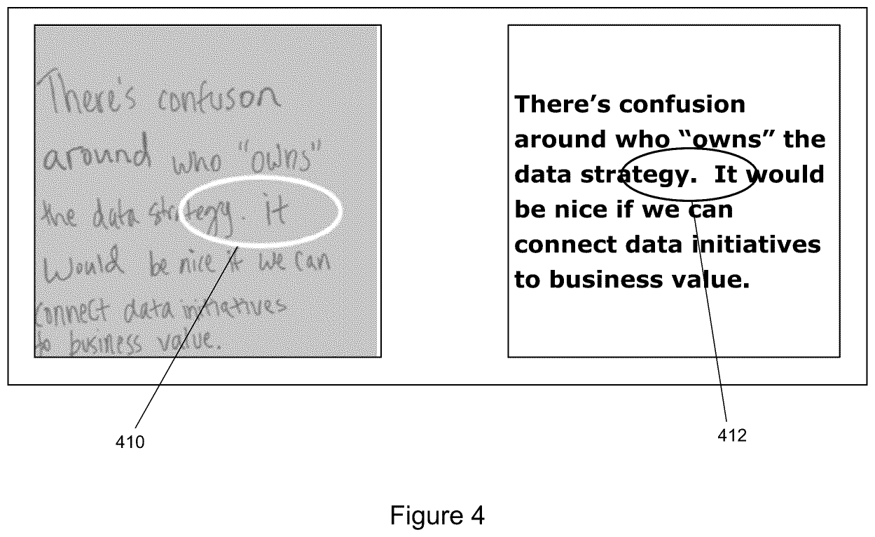

At step 112, natural language processing (NLP) may be applied to correct errors, such as typographical errors, punctuation, format, style, etc. NLP may be supported by systems as described in U.S. Pat. No. 10,846,341, and continuation application U.S. patent application Ser. No. 17/100,019, the contents of which are incorporated by reference herein in their entirety. FIG. 3 illustrates how the system corrects a typographical error, according to an embodiment of the present invention. A spelling error 310 is shown corrected at 312. FIG. 4 illustrates applying a correction to punctuation, according to an embodiment of the present invention. A term in lowercase at 410 is shown capitalized at 412. Other errors may be identified and addressed. The system may also support stylistic, formatting and/or other preferences. For example, formatting may be applied for consistency, uniformity, etc.

In addition, NLP may also support Named Entity Recognition features within the description of Natural Language Processing that may be applied to disambiguate acronyms, jargon as well as other terminology that may appear on various digital notes.

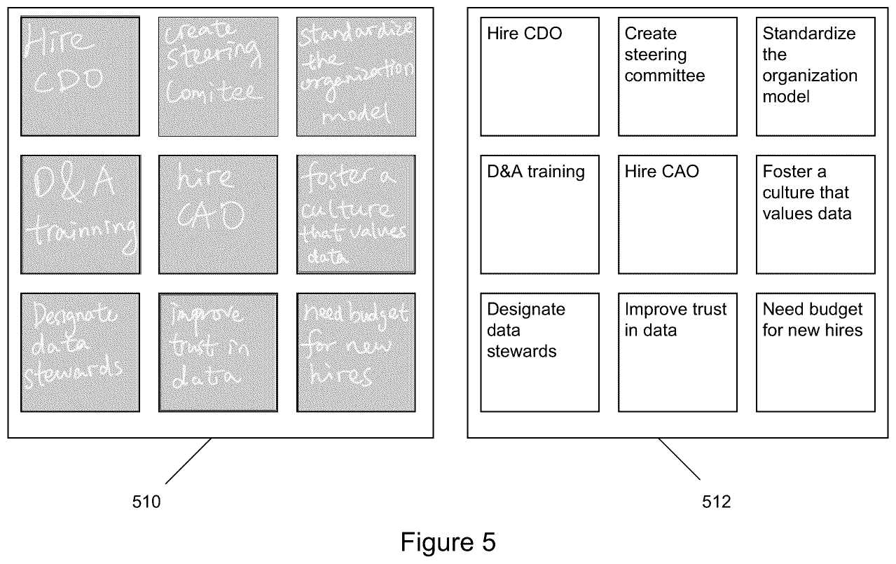

FIG. 5 illustrates how the system operates on multiple digital notes, according to an embodiment of the present invention. For example, the system may be applied in an in-person meeting. The meeting may occur at a single location, multiple locations and hybrid meetings where some participants are virtual or remote. For example, a remote session may be managed through conferencing applications as well as collaboration applications. The system may interact with various collaboration applications through APIs. The notes from the meeting from one or more locations may be collected and shown at 510 and then digitized at 512. The system may also support smaller breakout sessions at a location or across multiple locations.

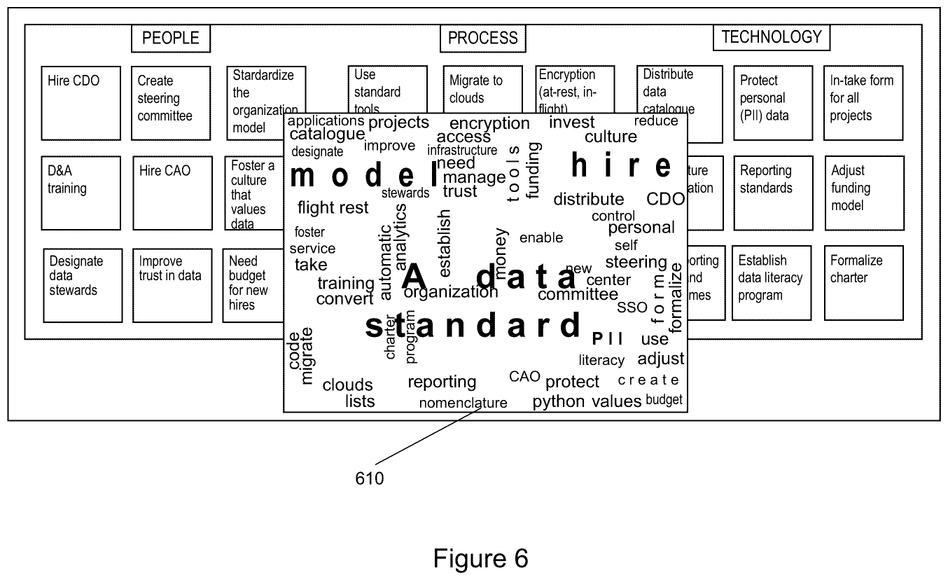

At step 114, NLP may be applied to create a word cloud or other graphic. FIG. 6 illustrates an example of a word cloud that graphically highlights a certain metric, such as word frequency, according to an embodiment of the present invention. In this example, a word cloud 610 may be a visual representation of word frequency where more common words are shown in larger text and/or bolder colors. Other metrics may be applied. Word clouds generally provide an indication of a theme or focus of discussion. Other graphics and illustrations may be provided.

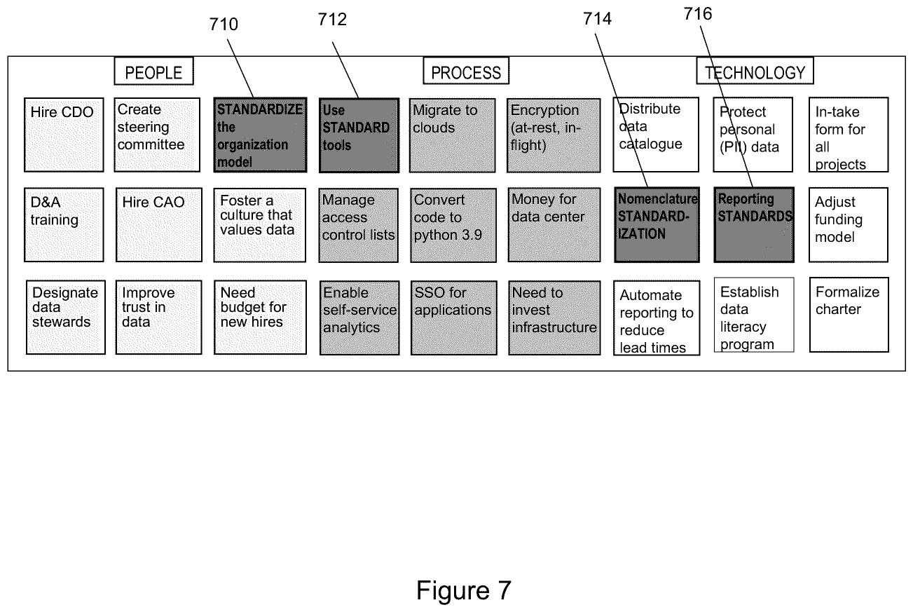

At step 116, the system may perform a search function to identify and highlight keywords including variations thereof. FIG. 7 illustrates a search for the keyword “standardize” where results are highlighted in a different color (e.g., shown in bold at 710, 712, 714, 716) and may also include variations of the term, according to an embodiment of the present invention.

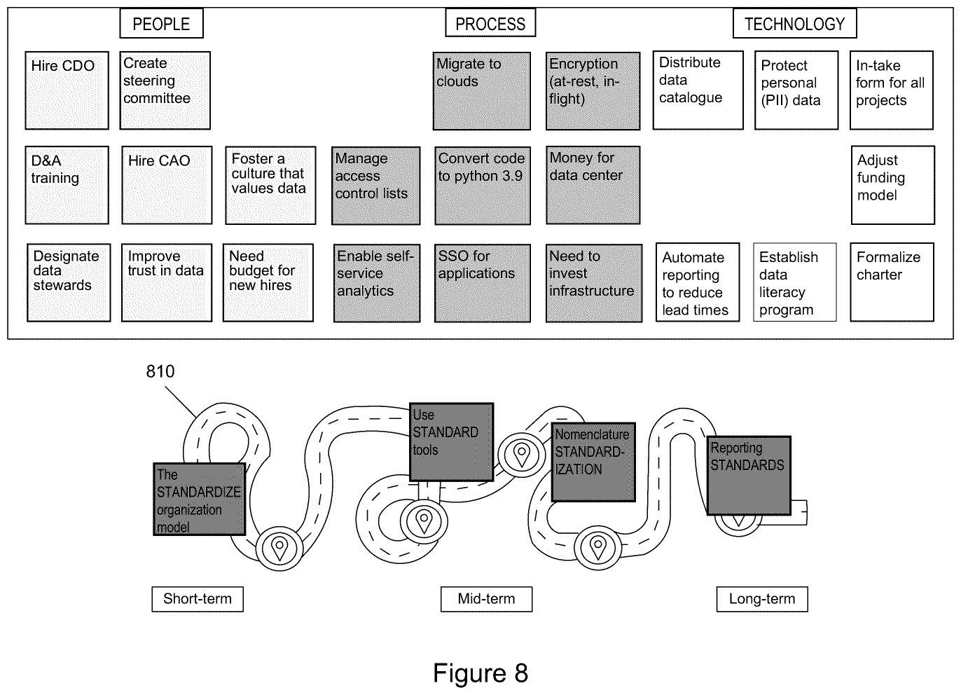

At step 118, the system may provide the ability to move and/or adjust digital notes on an icon, a graphic or other visual interface, such as a roadmap. FIG. 8 illustrates an example where highlighted digital notes may be moved or adjusted on another graphic, according to an embodiment of the present invention. This may be performed manually or automatically by the system. As shown in FIG. 8, the roadmap graphic 810 may include multiple phases including short term, mid-term and long term.

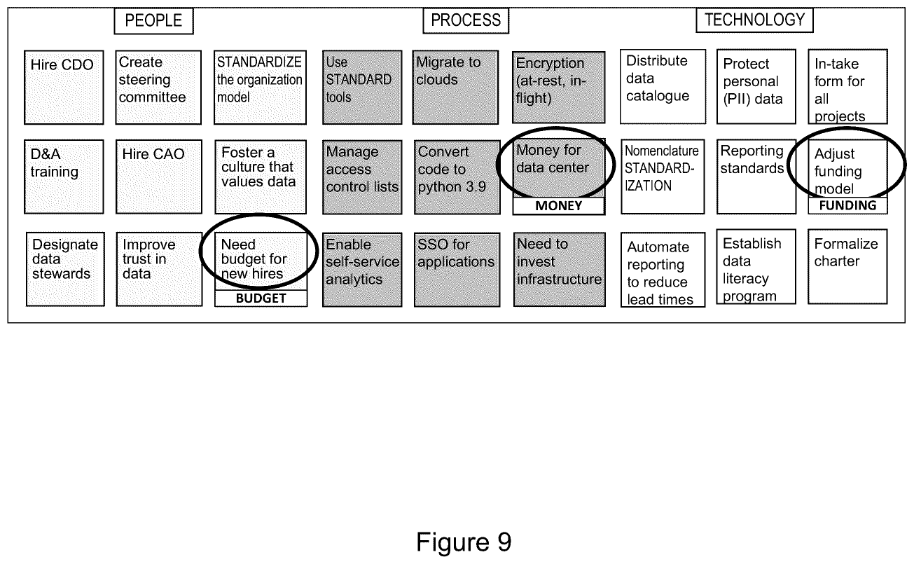

At step 120, NLP may be applied to identify and highlight themes (e.g., financial, booster, blockers, etc.). For example, Themes may leverage a well-defined, curated ONTOLOGY or TAXONOMY. FIG. 9 illustrates an example where a financial theme has been identified, according to an embodiment of the present invention. In this example, terms such as “budget,” “money,” “funding” and use of a currency symbol “$” may support a financial theme. Other themes may include Boosters (e.g., “opportunity,” “advantage,” “win,” “big,” “synergies”) and Blockers (e.g., “risk,” “challenge,” “threat,” “difficult”). Machine learning and/or Artificial Intelligence (AI) may be applied to identify other potential themes.

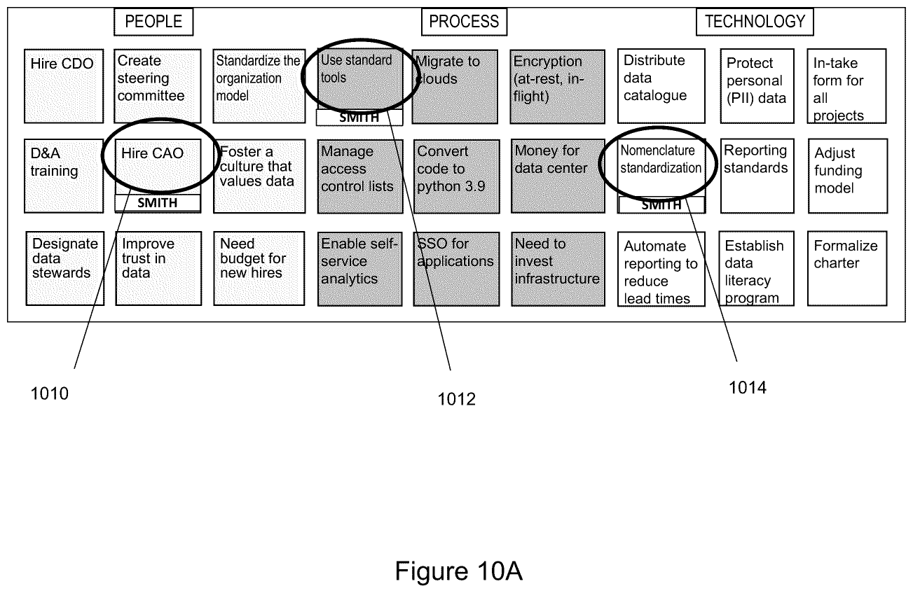

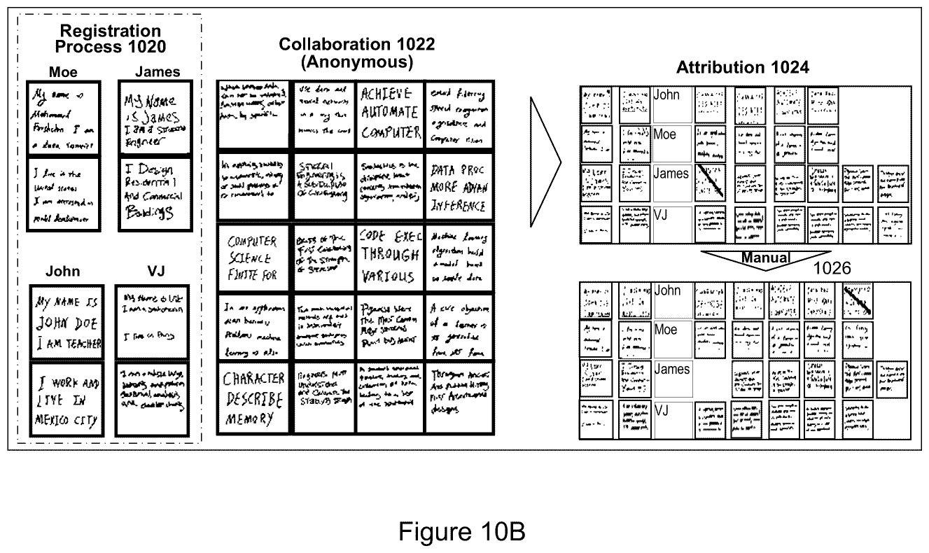

At step 122, analytics may be applied to identify attributes, such as authorship. FIG. 10A illustrates how handwriting may be used to attribute authorship, according to an embodiment of the present invention. In this example, the author “Smith” has been identified through a handwriting sample that may have been collected during a registration, while interacting with the system during a current or prior interaction, and/or other process. Other data samples may include demographics, roles, experience, etc. This information may be attributed to how participants perform and/or contribute during a session. Other metadata may include: time stamp; geospatial coordinates on the canvas; etc. As shown in FIG. 10A, digital notes 1010, 1012 and 1014 have been attributed to author “Smith.”

FIG. 10B illustrates author attribution, according to an embodiment of the present invention. FIG. 10B illustrates using handwriting to attribute authorship. An embodiment of the present invention is directed to applying attribution of digital notes through handwriting samples of participants. This may involve applying a machine learning model such as Convolutional Neural Network. Other models and networks may be implemented. For example, with two handwritten notes for a participant (as shown by Registration Process 1020), an embodiment of the present invention may take a screenshot of their collaboration digital notes (as shown by Collaboration 1022) and then classify the digital notes with a label that attributes authorship (as shown by Attribution 1024). Through the Registration Process, an embodiment of the present invention may analyze two or more digital notes that have been previously associated with an individual. These digital notes may then be used to classify and attribute authorship. In addition, a human in the room may further confirm authorship (as shown by Manual 1026). Additional metadata associated with the author (e.g., department, role, years of experience, etc.) may be applied. This may assist in further analyzing content of digital notes contextually.

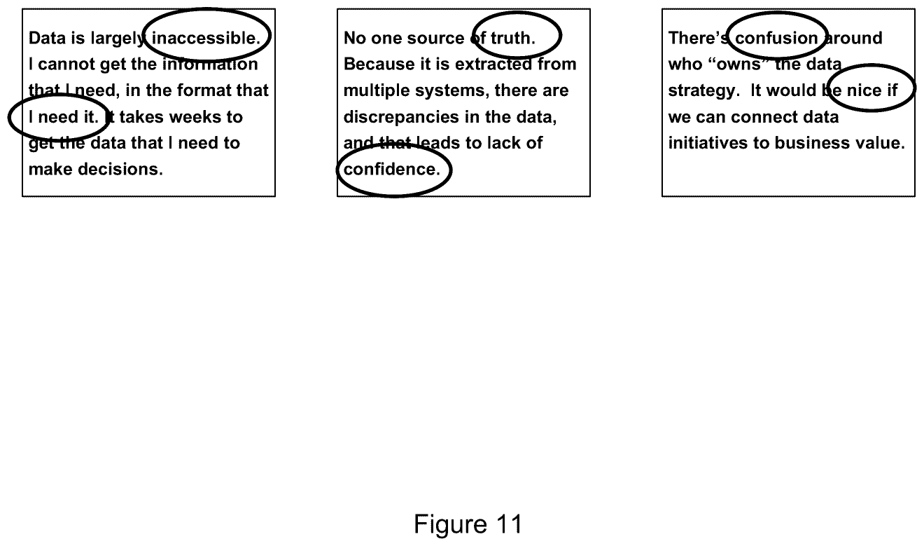

At step 124, NLP may be applied to discern sentiment (e.g., positive, negative, neutral, etc.). FIG. 11 illustrates how sentiment may be identified, according to an embodiment of the present invention. An overall positive sentiment may be identified through use of words such as “opportunity,” “win,” “insight,” etc. A negative sentiment may be determined through use of terms such as “confusion,” “inaccessible,” “lack of confidence,” “issue,” etc. Other words may be identified to represent an entity's core values, objectives, etc.

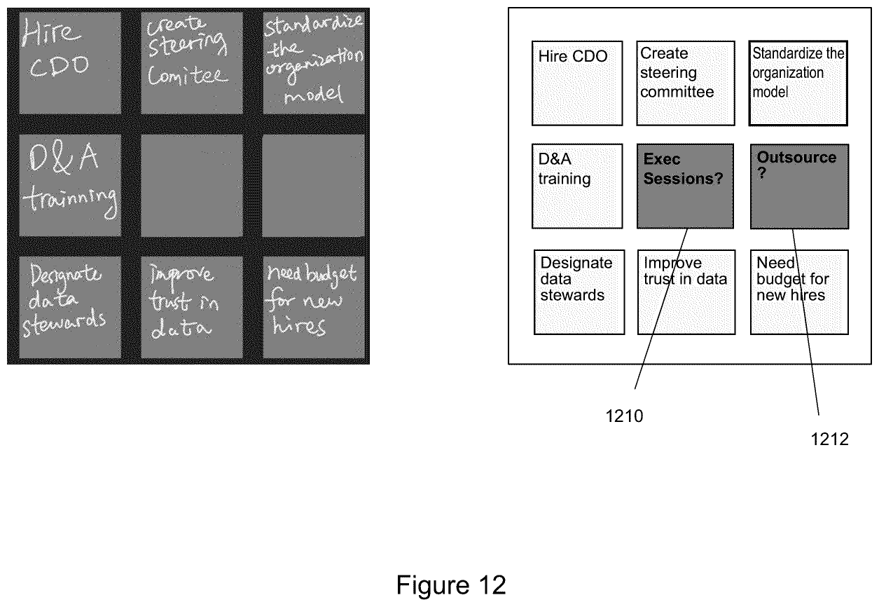

At step 126, a recommender engine may be applied to provide suggestions. FIG. 12 illustrates suggestions such as “Exec Session?” 1210 and “Outsource?” 1212 according to an embodiment of the present invention. The recommender engine may perform analytics on the existing notes to determine a next step or other item/action to consider. Machine learning may be applied to identify other potential suggestions. The Recommendation Engine may be based on Machine Learning (e.g. Collaborative Filtering, Content Filtering) or it may be based on Generative AI.

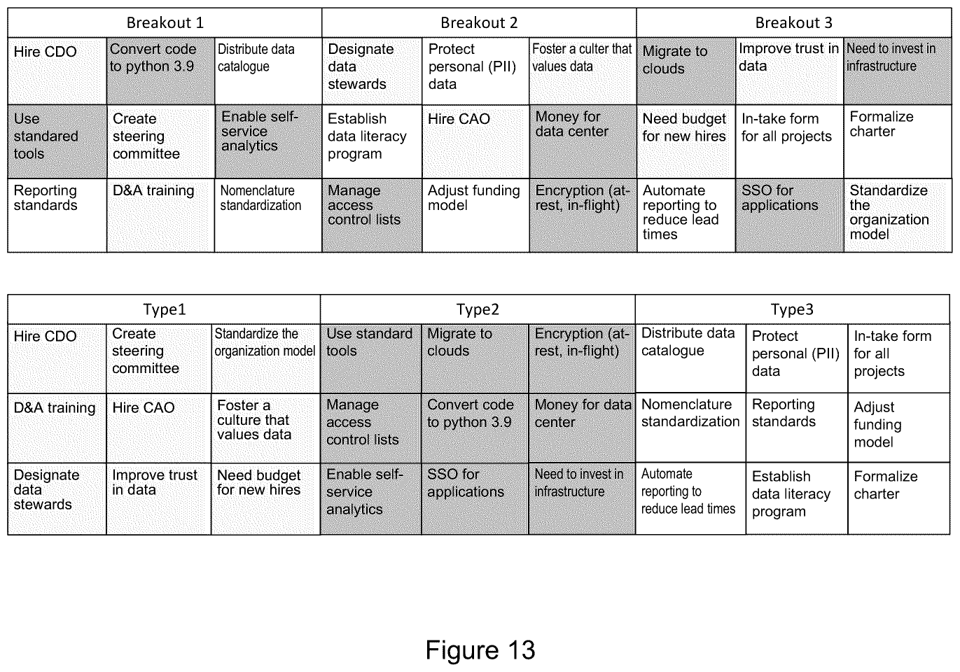

At step 128, a classifier may be applied to cluster related digital notes. FIG. 13 illustrates how digital notes may be categorized, according to an embodiment of the present invention. For example, digital notes may be related by theme, sentiment, words, authorship, location, timing, etc. Machine learning and/or a clustering algorithm may be applied to classify digital notes into various types.

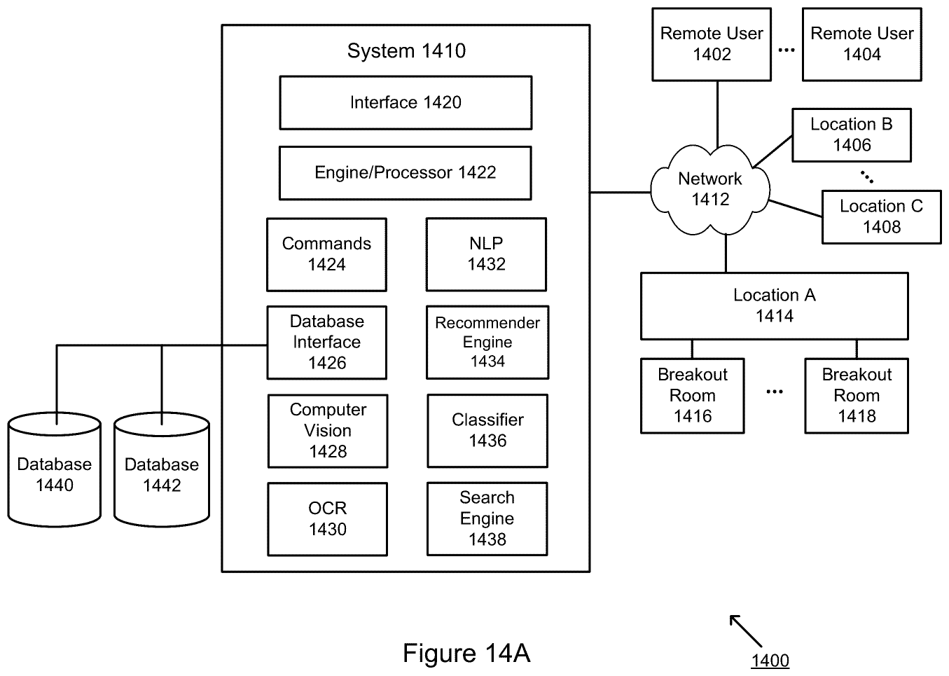

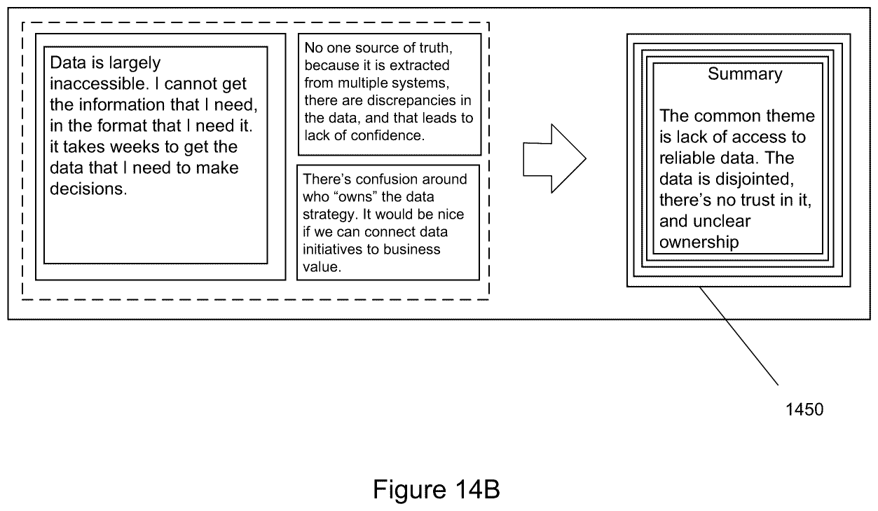

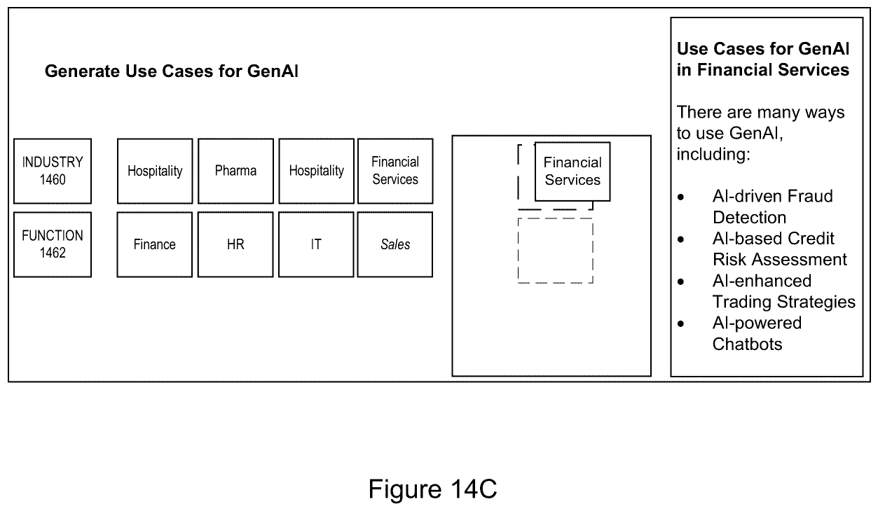

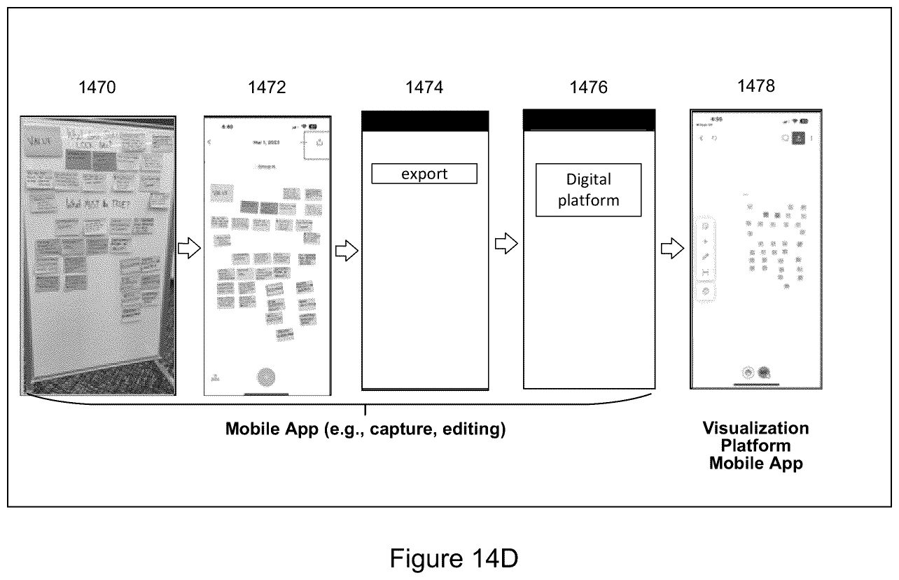

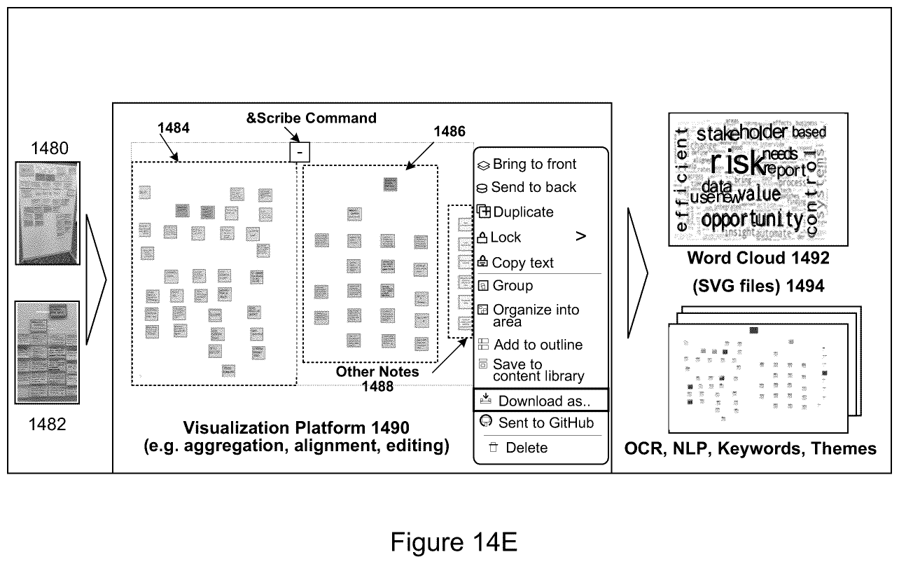

FIG. 14A is an exemplary system diagram, according to an embodiment of the present invention. System 1410 executes and supports handwritten note detection and recognition through various configurations and architectures. Participants at various physical locations may communicate with System 1410 via Network 1412. In addition, Remote Users 1402, 1404 may connect with System 1410 through various computing devices.

An embodiment of the present invention is directed to creating digital notes on a digital screen platform at a physical site. Another embodiment involves remote users who are working from home or other location, e.g., Location A 1414, Breakout Room 1416, Breakout Room 1418, Location B 1406, Location C 1408. In this example, remotes users may have software executing on a laptop, or access a software through a browser interface. These remote users may be active participants in an interactive session. According to an embodiment of the present invention, the software may generally represent a visual collaboration and dynamic multimedia presentation.

An embodiment of the present invention is directed to supporting multiple interfaces and canvases. For example, an embodiment of the present invention may concurrently support a plurality of collaboration and visualization platforms. The system may access data from across a collection of active canvases to execute a command. For example, the system may execute a command that inserts a job into an asynchronous queue where jobs may be processed on a first-in-first-out (FIFO) or other basis.

System 1410 may include Interface 1420 that supports various interactions on devices including mobile devices, smart devices, computers, laptops, tablets, etc. Interface 1420 may enable users and/or other entities to interact with Engine/Processor 1422. Interface 1420 may support various applications including browsers, mobile interfaces, dashboards, interactive interfaces, etc. For example, System 1410 may interact with Interface 1420 through an API. In this example, Interface 1420 may be provided through a separate service or provider. FIG. 14A is illustrative only and may support various other configurations and architectures.

Users may interact with an embodiment of the present invention using various devices including mobile devices and handhelds. Participants tend to value a session in direct proportion to the level of interaction and the quantity of “work” that is done toward analyzing a business problem. As such, many exercises seek to illicit individual responses to a prompt and then collaborate as a team to form a consensus. A challenge recognized by an embodiment of the present invention is that sometimes individuals are asked to engage in a task that is complex, time consuming, and based on content. Another challenge is identifying who provided a particular response and in what context. Yet another challenge involves compiling and analyzing responses accurately and expeditiously.

An embodiment of the present invention is directed to synchronizing inputs made on individual mobile devices or handhelds with an interface that is running at a location, e.g., in the front of the room. Using an API, an embodiment of the present invention may programmatically control the setup and/or extraction of content displayed on each individual handheld. An embodiment of the present invention may also apply external services and/or analytics to further process individual responses.

An embodiment of the present invention may then depict individual responses and/or the groups' collective work product onto a front display and presentation sequencing.

Using handhelds, participants may peruse content and provide detailed, individual responses. Each handheld may be assigned to a particular stakeholder so that the system may fully attribute “identity” and “context” as well as other metadata. Individual responses may be “revealed” on a front-monitor and/or compiled seamlessly into group work-product.

Engine/Processor 1422 may support various functions and processes via modules including Commands 1424, Database Interface 1426, Computer Vision 1428, OCR 1430, NLP 1432, Recommender Engine 1434, Classifier 1436, and Search Engine 1438. Other functions and features may be supported. Engine/Processor 1422 may interact with modules via an API or other interface. Other configurations may be supported.

Commands 1424 may represent a set of commands that facilitate user interaction and creation of content and other features. The following is an exemplary set of commands for illustration purposes. Other commands and variations may be implemented.

&SET GRID [number of rows] [number of columns] [color of digital notes] creates on-screen digital notes in the specified color, and in a grid with the requested number of rows and columns. With this command, a note grid may be named. For example, a user may click on a note to see the name. The creation of a well-defined and structured grid enables effective and algorithmic use of Computer Vision to detect edges.

&SCRIBE enables group OCR of an entire grid or group of digital notes. This command returns a pointer note which determines placement of OCR-ed results. A resulting note grid may be named. Generally, an embodiment of the present invention may include a return of SYSTEM MESSAGE digital notes. The SYSTEM MESSAGE note may then be manually moved by a facilitator to a location on the canvas, and the SVG graphic may be inserted as an offset. Meanwhile, the SYSTEM MESSAGE may be used for other purpose including: instructions; error checking, etc.

&KEYWORD [keyword] searches for keywords in OCR-ed digital notes. Resulting search hits may be highlighted. This may include a different color note and/or keyword text in all-caps. Other colors, fonts, graphics may be applied.

&WORD CLOUD is similar to &Scribe, but instead returns a word cloud graphic instead of a note grid. Other graphics and/or illustrations may be provided.

&DELETE [grid name] deletes an entire grid or group of digital notes, as referenced by a grid name or other identifier.

&DELETE ALL deletes all digital notes generated.

&TURN OFF sets the system to idle.

&TURN ON brings the system back from idle.

&SESSION START inserts a flag and timestamp into the database, indicating when a session starts. This supports data mining and other efforts.

&SESSION STOP inserts a flag and timestamp into the database, indicating when a session ends. This also supports data mining and other efforts.

&RELATED finds related digital notes for a specific note. This command may find and highlight a related set of digital notes (based on a clustering algorithm, for example). During sessions, this may provide a way to determine how an important “idea” appears throughout the digital notes that are created in a session.

&THEME enables a facilitator to contribute words to a particular taxonomy. For example, the word “Euro” might be added ad hoc. In this example, a record would then be added accordingly to a table that is LOCAL to the particular session, or a GLOBAL table that may apply to all subsequent sessions. This may be helpful when gathering insights and expanding databases, all in real time.

Other commands may include &ATTRIBUTE, &SUGGEST, &CLUSTER, &QUESTION, &SELECT and &SENTIMENT. For example, the &QUESTION command may invoke a search engine to peruse a library of artifacts (e.g., a database, document repository, content management system, and/or an interface to a Knowledge Graph) and provide answers to a user-specified question or query by using machine learning question-response algorithms.

Another command may include &GENERATE. In this example, a screenshot of specific digital notes may serve as arguments, where Generative AI is applied on the back end, and then one or more digital notes may be inserted as results onto a digital board, such as a video board.

For example, &GENERATE command may be applied to summarize a set of digital notes. FIG. 14B is an example of a generate command, according to an embodiment of the present invention. An embodiment of the present invention is directed to creating a summary of digital notes through a Generative AI model, as described in U.S. application Ser. No. 18/477,817, “Artificial Intelligence Enhanced Knowledge Framework,” filed Sep. 29, 2023, the contents of which are incorporated by reference herein in their entirety. A summary of multiple digital notes is shown by summary note 1450.

Another example of &GENERATE command may include a generation of use cases for Generative AI based on factors such as Industry only, Business Function only, or a combination of both “Industry AND Business Function” together. FIG. 14C is an example of a generate command, according to an embodiment of the present invention. Industry 1460 may include: hospitality, pharmaceuticals, financial services, etc. Function 1462 may include: finance, human resources (HR), Information Technology (IT) and sales. Use cases may include: fraud detection, credit risk assessment, trading strategies and chatbots.

Another example of &GENERATE may include creating digital notes that complement other digital notes that were written by another entity, such as clients, partners, vendors, users, etc. FIG. 12 is an example of a generate command, according to an embodiment of the present invention. As shown in FIG. 12, generative AI may be applied to propose new digital notes.

An embodiment of the present invention may access a knowledge management (KM) system that stores and manages data that has been curated and refined for an organization's use. This data may be internal, managed by internal data managers, or external to an organization.

Another example of &GENERATE may include creating a contextual glossary on the fly that highlights digital notes based on keywords that are associated with a particular theme. FIG. 9 is an example of a generate command, according to an embodiment of the present invention. As shown in FIG. 9, a contextual glossary may be generated. An embodiment of the present invention may support pre-existing glossaries as well as glossaries that may be curated on the fly contextually using Generative AI.

The commands may receive inputs and generate outputs in various forms including TEXT. Other variations may use JPEG files as inputs and generate graphic outputs.

As shown in FIG. 14A, Database Interface 1426 communicates with various storage components. An embodiment of the present invention may write metadata and data to a database, as shown by Database 1440, 1442, for subsequent mining. Data may include an identifier, timestamp, j son response, src (system reference codes), command called (e.g., OCR, keyword, setgrid, etc.) and other forms of data. For an intra-session, an embodiment of the present invention may measure adherence of session timing and flow to a pre-set agenda. For inter-sessions, an embodiment of the present invention may identify systemic issues (e.g., typos, questions, etc.) that arise so that these may be proactively mitigated in subsequent sessions. In addition, machine learning may be applied to identify potential themes that may be used in a subsequent session. According to another example, machine learning may be applied to identify potential suggestions to fill empty digital notes (e.g., stickies). For example, a recommender engine may use Collaborative Filtering and/or Content Filtering features. In addition, an internal Knowledge Management (KM) system may leverage AI and/or Generative AI capabilities to identify and rank themes discovered within digital notes. Additionally, an embodiment of the present invention may be configured to use a Knowledge Management platform to determine themes and/or summarize themes from the digital notes.

An embodiment of the present invention may be directed to mining metadata which may be performed intra- and inter-sessions. In addition to measuring adherence to an agenda, an embodiment of the present invention may take stock of delays, and potentially compress downstream exercises so that the clients can leave the session on time. Similarly, through attribution, an embodiment of the present invention may determine whether there is wide-spread participation/engagement in certain exercises. An embodiment of the present invention may determine whether ideas/questions that are socialized at the beginning of or during a session are ultimately answered by the end of a session. Other actions relating to ideation, problem-solving, etc. may be supported.

Computer Vision 1428 may be applied to parse an image into discrete objects (e.g., rectangular or square shaped objects, etc.). An embodiment of the present invention may discern edges of digital notes of varying shapes and sizes arranged in a grid or other format. For example, the system may implement functions for edge detection and finding contours to detect digital notes functions and also detect specific color schemes to positive OCR-ed text into a detected contour.

OCR 1430 may be applied to convert handwritten characters into digital text. Other character recognition technology and algorithms may be applied.

NLP 1432 may be applied to repair errors. This may include fixing typographical errors, correcting punctuations and addressing other grammatical issues. NLP may be supported by systems as described in U.S. Pat. No. 10,846,341, and continuation application U.S. patent application Ser. No. 17/100,019, the contents of which are incorporated by reference herein in their entirety. NLP 1432 may also be applied to locate keywords (e.g., explicit, thematic, etc.), then augment the string (e.g., uppercase, bold, italics, etc.) and change the note color (or add a graphic) to highlight and emphasize. In addition, NLP 1432 may be applied to compare ad hoc, handwritten digital notes to a set of pre-loaded samples, to attribute authorship and tag accordingly. Other features and analytics may be applied.

An embodiment of the present invention may insert a graphic, such as a Scalable Vector Graphic (SVG), onto a canvas with specific placement as an offset to a pointer.

According to an example, empty digital notes may be dropped altogether from the SVG graphics that were created. According to another example, the empty digital notes may be called forward into the graphics that are created.

Recommender Engine 1434 may provide suggestions that complement user-provided digital notes.

Classifier 1436 may group digital notes that have a relationship or other similarity.

Search Engine 1438 may access a database of artifacts and/or other source of information to respond to user-specified questions. This may include a database, document repository, content management system, and/or even an interface to a Knowledge Graph.

An embodiment of the present invention is directed to a collaboration feature. For example, collaboration sessions may be conducted at a location with interactive digital screens (e.g., collaboration and visualization platforms). This may also include sessions that involve paper notes or other physical annotations. An embodiment of the present invention may be extended to include functionality that captures digital notes via photos and/or mobile applications where the digital notes may be uploaded to a digital platform and commands may be executed.

FIGS. 14D and 14E are examples of a collaboration feature, according to an embodiment of the present invention.

FIG. 14D illustrates capturing digital notes, according to an embodiment of the present invention. 1470 illustrates an image from an in-person session. 1472 illustrates a digitized version of the captured image. 1474 and 1476 illustrate a process that uploads the captured digital notes into a digital platform which may be accessed via a mobile app, as shown by 1478. Edits and other interactions may be supported.

FIG. 14E illustrates analysis of digital notes, according to an embodiment of the present invention. 1480 and 1482 illustrate images from in-person sessions which may be at the same or different locations. The images may be uploaded to a Visualization Platform 1490 for aggregation, alignment and editing. For example, each note may be converted to a digital note as shown by 1484 and 1486 through a command, such as &SCRIBE. Additional notes may be supported by Other Notes 1488. The digital notes may be represented by a graphic, such as Word Cloud 1492 and/or SVG Files 1494. Other analysis may be supported through OCR, NLP, keywords, themes, etc. Other interactions may be supported.

An embodiment of the present invention may leverage Generative AI to create a Knowledge Framework and further use the Knowledge Framework to assist in prompt engineering of Generative AI. The Knowledge Framework may incorporate taxonomies, ontologies as well as curated artifacts from various sources. For example, an embodiment of the present invention may query the Knowledge Framework for information and context. The system may then publish anonymized client insights to this Knowledge Framework to expand its corpus. The details concerning the Knowledge Framework are provided in pending U.S. patent application Ser. No. 18/477,817, “Artificial Intelligence Enhanced Knowledge Framework,” filed Sep. 29, 2023, the contents of which are incorporated by reference.

System 1410 may store and manage data in various formats, including Databases 1440, 1442. An embodiment of the present invention may store information for later analysis and session improvement. This may involve excluding any data that is “personally identifiable” such as PII, PCI, PHI, etc. For example, if the digital note contains identifiable information, an embodiment of the present invention may REDACT identifiable information or EXCLUDE the note altogether.

Databases 1440, 1442 may represent a Postgres database deployed as a container and may store data in various forms, including tabular structure. An embodiment of the present invention may store NLP and OCR-related data in Postgres. In addition, as an optional feature, handwritten notes produced in sessions may be stored with consent of participants.

System 1410 may be communicatively coupled to Databases 1440, 1442. Databases 1440, 1442 may include any suitable data structure to maintain the information and allow access and retrieval of the information. Databases 1440, 1442 may be any suitable storage device or devices. The storage may be local, remote, or a combination thereof with respect to Databases 1440, 1442. Databases 1440, 1442 may have back-up capability built-in. Communications with Databases 1440, 1442 may be over a network, or communications may involve a direct connection between Databases 1440, 1442 and System 1410, as depicted in FIG. 14A. Databases 1440, 1442 may also represent cloud or other network based storage.

Networks may be a wireless network, a wired network or any combination of wireless network and wired network. Although Network 1412 is depicted as one network for simplicity, it should be appreciated that according to one or more embodiments, Network 1412 may comprise a plurality of interconnected networks, such as, for example, a service provider network, the Internet, a cellular network, corporate networks, or even home networks, or any of the types of networks mentioned above. Data may be transmitted and received via Network 1412 utilizing a standard networking protocol or a standard telecommunications protocol.

While FIG. 14A illustrates individual devices or components, it should be appreciated that there may be several of such devices to carry out the various exemplary embodiments. Users may communicate with various entities using any mobile or computing device, such as a laptop computer, a personal digital assistant, a smartphone, a smartwatch, smart glasses, other wearables or other computing devices capable of sending or receiving network signals.

The system 1400 of FIG. 14A may be implemented in a variety of ways. Architecture within system 1400 may be implemented as hardware components (e.g., module) within one or more network elements. It should also be appreciated that architecture within system 1400 may be implemented in computer executable software (e.g., on a tangible, non-transitory computer-readable medium) located within one or more network elements. Module functionality of architecture within system 1400 may be located on a single device or distributed across a plurality of devices including one or more centralized servers and one or more mobile units or end user devices. The architecture depicted in system 1400 is meant to be exemplary and non-limiting. For example, while connections and relationships between the elements of system 1400 are depicted, it should be appreciated that other connections and relationships are possible. The system 1400 described below may be used to implement the various methods herein, by way of example. Various elements of the system 1400 may be referenced in explaining the exemplary methods described herein.

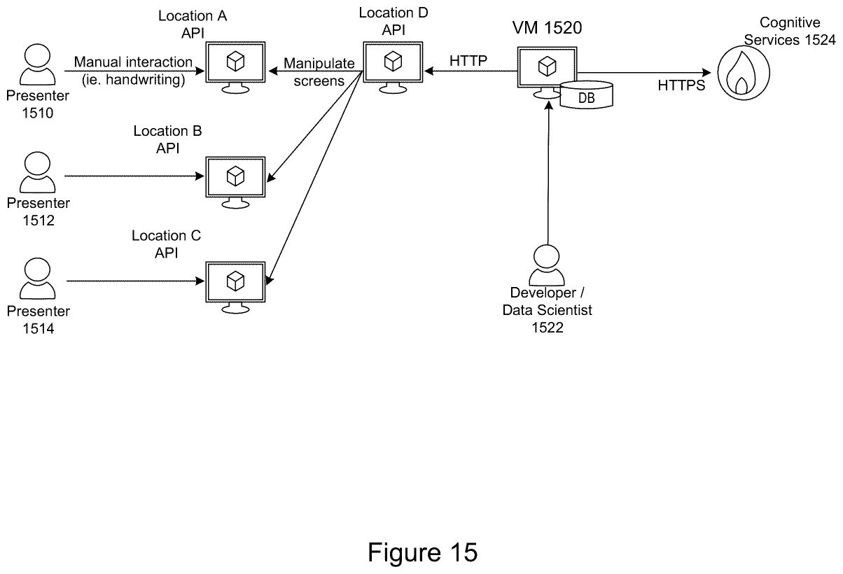

FIG. 15 illustrates an exemplary logical architecture, according to an embodiment of the present invention. As shown in FIG. 15, presenters 1510, 1512, 1514 may be located at the same or different locations, e.g., Location A, Location B, Location C and may interact with a digital input in various ways. Developer/Data Scientist 1522 may interact with a Virtual Machine (VM) 1520 that interacts with a digital interface (e.g., Location D API). Various services may be supported by Cognitive Services 1524.

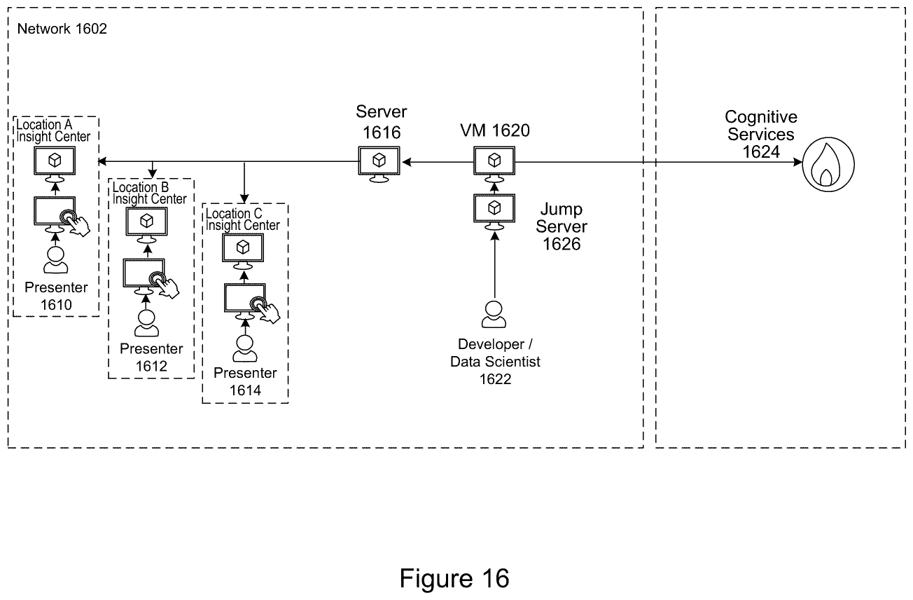

FIG. 16 illustrates an exemplary physical architecture, according to an embodiment of the present invention. As shown in FIG. 16, presenters 1610, 1612, 1614 may be located at the same or different locations, e.g., Location A, Location B, Location C and may interact with a digital input in various ways within Network 1602. Developer/Data Scientist 1622 may interact with a Virtual Machine (VM) 1620, via a Jump Server 1626, that interacts with Server 1616 that communicates with digital interfaces at Locations A, B, and C. Various services may be supported by Cognitive Services 1624.

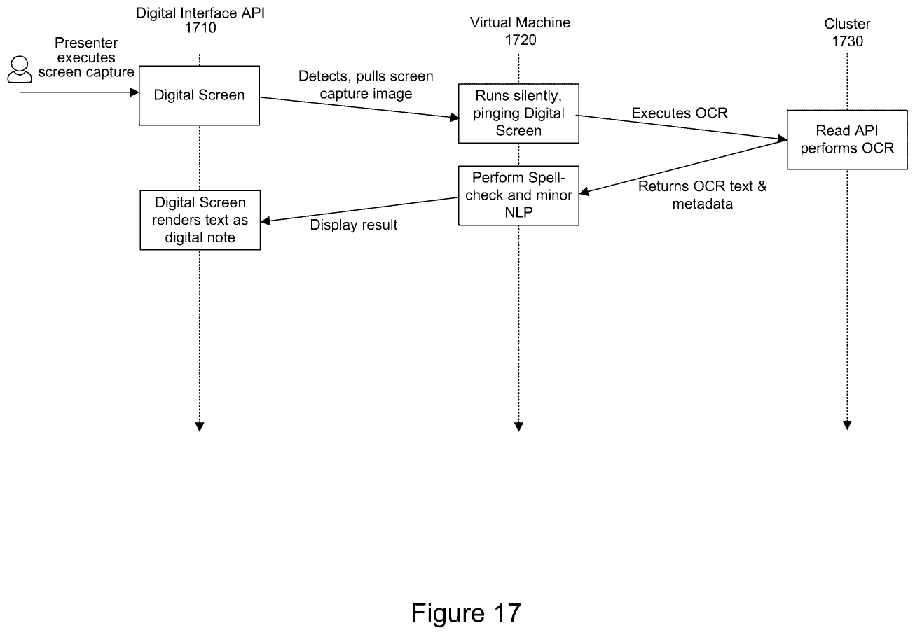

FIGS. 17-19 illustrate exemplary process flows, according to an embodiment of the present invention. FIG. 17 is an exemplary process flow that illustrates OCR and NLP processing. FIG. 17 illustrates interactions between Digital Interface API 1710, Virtual Machine 1720 and Cluster 1730.

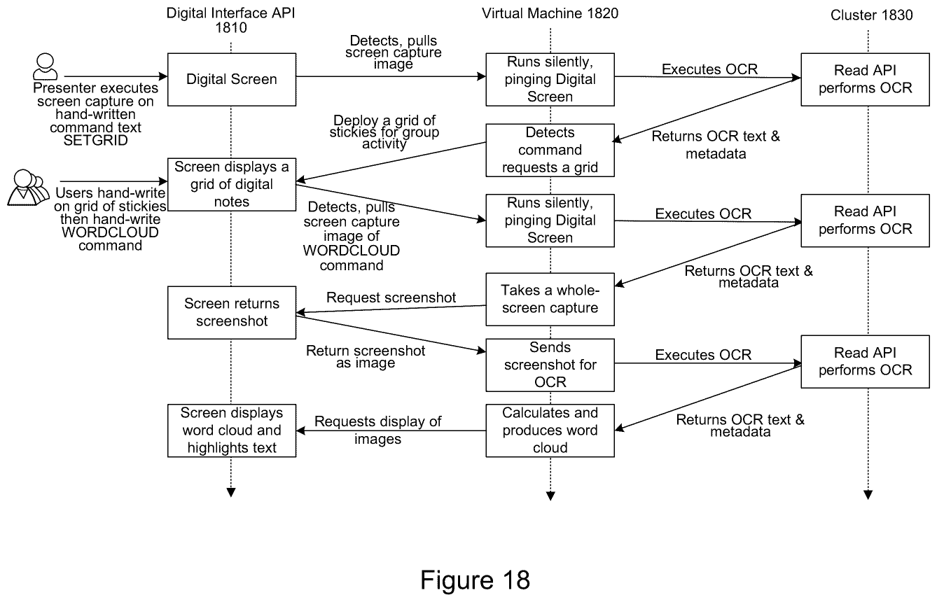

FIG. 18 is an exemplary process flow that illustrates Word Cloud and Key Concept Highlighting. FIG. 18 illustrates interactions between Digital Interface API 1810, Virtual Machine 1820 and Cluster 1830.

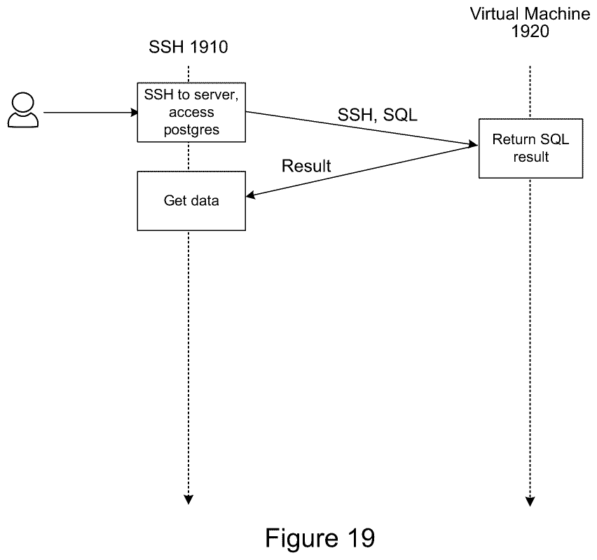

FIG. 19 is an exemplary process flow that illustrates Data Mining. FIG. 19 illustrates interactions between SSH 1910 and Virtual Machine 1920. SSH represent secure shell (SSH) protocol that enables secure communications. As shown in FIG. 19, SQL results are provided in response to a request. Other results in other formats may be supported.

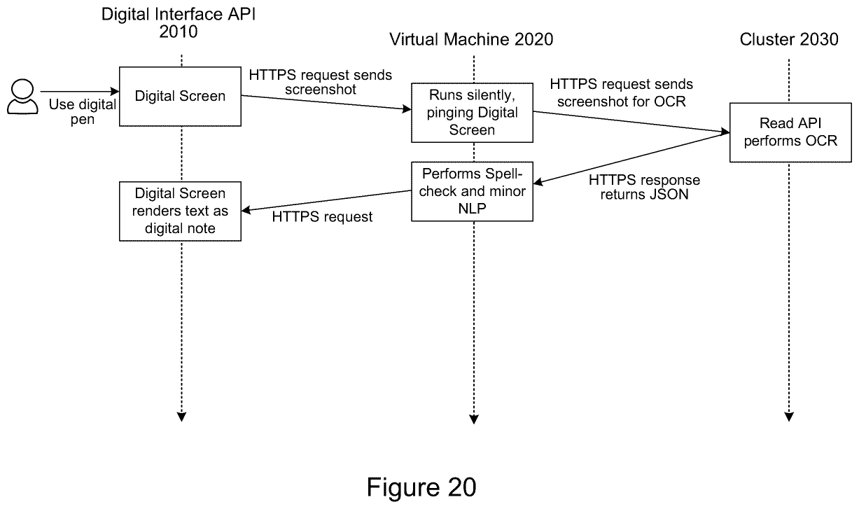

FIGS. 20-22 illustrate exemplary data flows, according to an embodiment of the present invention.

FIG. 20 is an exemplary data flow that illustrates OCR and NLP processing. FIG. 20 illustrates interactions between Digital Interface API 2010, Virtual Machine 2020 and Cluster 2030.

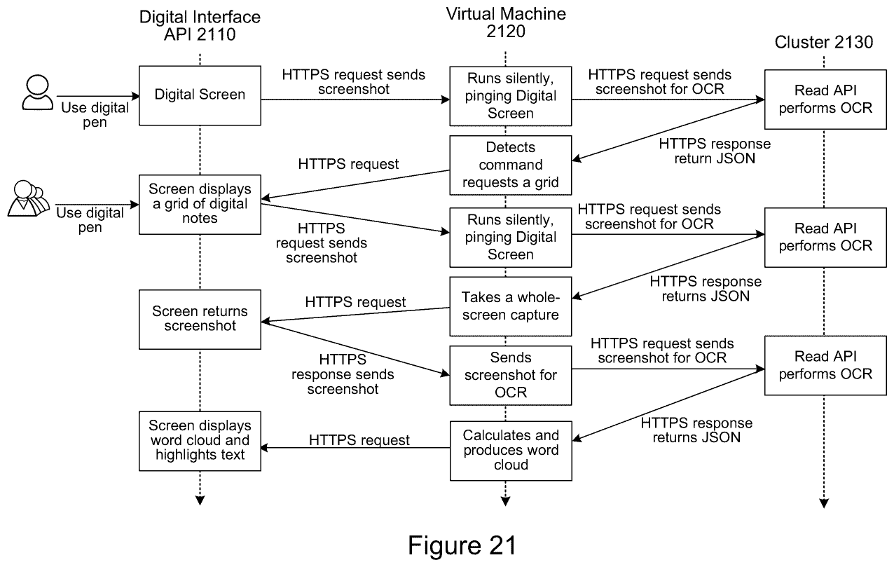

FIG. 21 is an exemplary data flow that illustrates Word Cloud and Key Concept Highlighting. FIG. 21 illustrates interactions between Digital Interface API 2110, Virtual Machine 2120 and Cluster 2130.

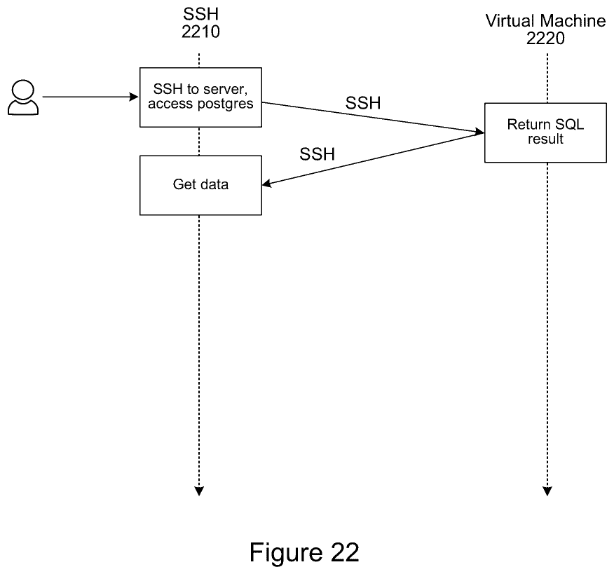

FIG. 22 is an exemplary data flow that illustrates Data Mining. FIG. 22 illustrates interactions between SSH 2210 and Virtual Machine 2220. As shown in FIG. 22, SQL results are provided in response to a request. Other results in other formats may be supported.

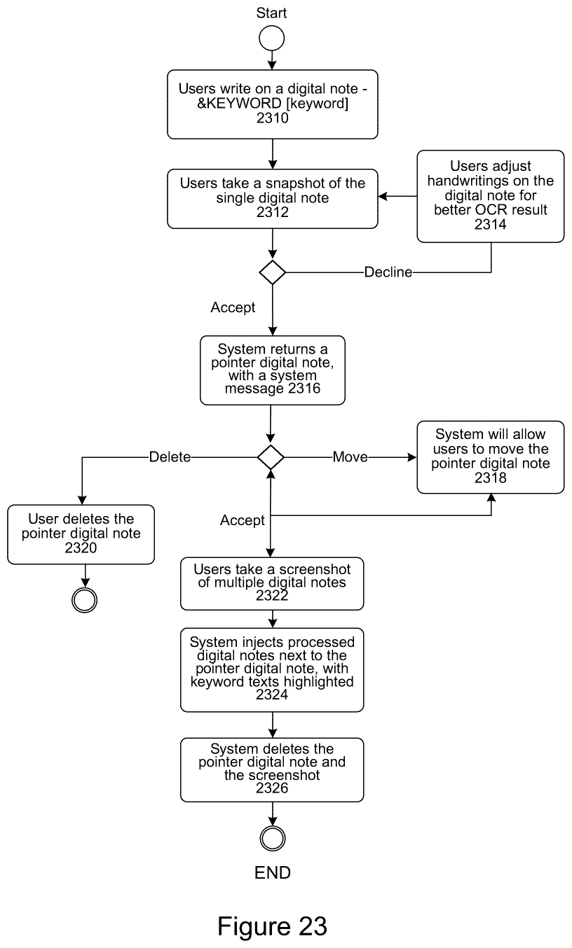

FIG. 23 illustrates an exemplary flowchart that describes searching and highlighting keywords, according to an embodiment of the present invention. At step 2310, user initiate a keyword command by writing on a digital note. At step 2312, users may take a snapshot of the digital note or use another data input. If the snapshot is accepted, the system may return a pointer digital note with a system message at step 2316. If the snapshot is declined, the user may adjust the digital note. The user may delete the pointer digital note at step 2320. The system may allow the user to move the pointer digital note at step 2318. If accepted, the user may take a screenshot of multiple digital notes at step 2322. The system may then inject processed digital notes with highlighted keyword texts at step 2324. The system may then delete the pointer digital note and screenshot at step 2326. While the process of FIG. 23 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

An embodiment of the present invention may support various computer vision applications relating to edge and color detection, for example.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more of them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages will be apparent to those skilled in the art from consideration of the specification and practice of the embodiments disclosed herein. The specification and examples should be considered exemplary.

What is claimed is:

1. A computer-implemented system that digitizes and mines handwritten notes to support real-time collaboration, the system comprising:
an interface that communicates with a digital touch interface at a location during a collaboration session; and
a computer processor that is connected to the interface and further programmed to perform the steps of:
applying computer vision processing to parse an image displayed on the digital touch interface into a set of objects that comprise a set of handwritten notes;
performing optical character recognition processing on the set of handwritten notes to identify a corresponding set of text strings;
applying natural language processing to identify one or more keywords based on the set of text strings and making the one or more keywords available in real-time;
applying a recommender engine to identify one or more suggestions that support the set of text strings and making the one or more suggestions in real-time; and
applying a classifier to identify relationships between the set of text strings and making the relationships available in real-time.

2. The computer-implemented system of claim 1, wherein the interface communicates with a second digital touch interface at a second location.

3. The computer-implemented system of claim 1, wherein the computer processor is further programmed to perform the steps of: applying the natural language processing to correct errors wherein the errors comprise typographical errors and punctuation; and applying the natural language processing to create a word cloud graphic based on the corresponding set of text strings wherein the word cloud graphic is based on a metric.

4. The computer-implemented system of claim 1, wherein the computer processor is further programmed to perform the step of: applying the natural language processing to attribute authorship to each of the text strings based on a writing sample and making the authorship available in real-time.

5. The computer-implemented system of claim 1, wherein the natural language processing is applied to identify a company business theme in real-time.

6. The computer-implemented system of claim 1, wherein the authorship is determined for each set of text strings.

7. The computer-implemented system of claim 1, wherein the writing sample is predetermined.

8. The computer-implemented system of claim 1, wherein the writing sample is captured during a current collaboration session in real-time.

9. The computer-implemented system of claim 1, wherein the one or more suggestions comprise one or more action items.

10. The computer-implemented system of claim 1, wherein the one or more suggestions are generated using Generative AI.

11. A computer-implemented method that digitizes and mines handwritten notes to support real-time collaboration, the method comprising the steps of:
applying, via a computer processor, computer vision processing to parse an image displayed on a digital touch interface into a set of objects that comprise a set of handwritten notes, wherein the set of handwritten notes are captured during a collaboration session at a location;
performing, via the computer processor, optical character recognition processing on the set of handwritten notes to identify a corresponding set of text strings;
applying, via the computer processor, natural language processing to identify one or more keywords based on the set of text strings and making the one or more keywords available in real-time;
applying, via the computer processor, a recommender engine to identify one or more suggestions that support the set of text strings and making the one or more suggestions in real-time; and
applying, via the computer processor, a classifier to identify relationships between the set of text strings and making the relationships available in real-time.

12. The computer-implemented method of claim 11, wherein the interface communicates with a second digital touch interface at a second location.

13. The computer-implemented method of claim 11, further comprising the steps of:
applying the natural language processing to correct errors wherein the errors comprise typographical errors and punctuation; and
applying the natural language processing to create a word cloud graphic based on the corresponding set of text strings wherein the word cloud graphic is based on a metric.

14. The computer-implemented method of claim 11, further comprising the step of: applying the natural language processing to attribute authorship to each of the text strings based on a writing sample and making the authorship available in real-time.

15. The computer-implemented method of claim 11, wherein the natural language processing is applied to identify a company business theme in real-time.

16. The computer-implemented method of claim 11, wherein the authorship is determined for each set of text strings.

17. The computer-implemented method of claim 11, wherein the writing sample is predetermined.

18. The computer-implemented method of claim 11, wherein the writing sample is captured during a current collaboration session in real-time.

19. The computer-implemented method of claim 11, wherein the one or more suggestions comprise one or more action items.

20. The computer-implemented method of claim 11, wherein the one or more suggestions are generated using Generative AI.
